(19) United States
(12) Patent Application Publication
(10) Pub. No.: US 2016/0255814 A1
(43) Pub. Date: Sep. 8, 2016

(54) DIGESTIBLE ANIMAL TOY

(71) Applicant: Sheri Kyle, Cincinnati, OH (US)

(72) Inventor: Sheri Kyle, Cincinnati, OH (US)

(21) Appl. No.: 15/056,084

(22) Filed: Feb. 29, 2016

Related U.S. Application Data
(60) Provisional application No. 62/126,940, filed on Mar. 2, 2015.

(51) Int. Cl. A01K 11/00; B65B 1/04

(52) U.S. Cl. CPC A01K 15/026; B65B 1/04

(57) ABSTRACT

An animal toy comprises an outer shell defining a first internal volume therewithin, the outer shell comprised of a fabric material. The animal toy also includes a barrier shell concealed within the first internal volume of the outer shell, the barrier shell defining a second interior volume therewithin, the barrier shell comprised of a moisture barrier that prevents moisture from passing from the outer shell into the second interior volume. Still further, the animal toy comprises a plurality of capsules contained within the second interior volume of the barrier shell, that are water-dissolvable.

### CROSS REFERENCE TO RELATED APPLICATIONS

This application claims the benefit of U.S. Provisional Patent Application Ser. No. 62/126,940, filed Mar. 2, 2015, entitled DIGESTIBLE ANIMAL TOY, the disclosure of which is hereby incorporated herein by reference.

### BACKGROUND

The present disclosure relates in general a toy for pets, and in particular, to an animal toy that is not meant to be eaten by an animal, but is digestible nevertheless.

Animals such as dogs, receive benefits from activities that involve playing with toys. A common toy used to entertain dogs is a rope, which is typically used to play a popular game of “tug of war”. The use of the rope for play can be effective, for instance, in curbing a dog's desire to chew on other items such as furniture, clothing, etc. However, rope toys may lead to broken teeth and bleeding gums in the dog due to over-exuberant tugging by the dog. Fibers from the rope may also become entangled around the dog's teeth. The dog may also swallow long strands of rope fiber, resulting in the potential for intestinal damage, necessitating surgery.

Dog toys can also take the form of hard, plastic toys and nylon toys. Such toys provide a hard material that many dogs enjoy chewing. However, such hard toys can cause chips in the enamel of the dog's teeth, and may ultimately lead to tooth fractures if the dog chews too hard on the toy.

Dog toys can still further take the form of edible dog toys. Such toys may be hard, e.g., rawhide, bones, or hooves. Such edible dog toys may also be soft, e.g., cloth intended to be opened by the dog to reveal treats. However, providing a dog with an edible toy may lead to the dog acquiring bad habits, essentially training the dog to digest all that the dog chews on.

### BRIEF SUMMARY

According to aspects of the present disclosure, an animal toy comprises an outer shell defining a first internal volume therewithin. For instance, the outer shell may be comprised of a fabric material, e.g., fleece. The animal toy also includes a barrier shell concealed within the first internal volume of the outer shell. The barrier shell defines a second interior volume therewithin, and is comprised of a moisture barrier that prevents moisture from passing from the outer shell into the second interior volume. Still further, the animal toy comprises a plurality of capsules contained within the second interior volume, i.e., within the volume of the barrier shell, that are water-dissolvable.

### BRIEF DESCRIPTION OF THE SEVERAL VIEWS OF THE DRAWINGS

FIG. 1 is a view of an example digestible animal toy;

FIG. 2 is an internal view of the digestible animal toy of FIG. 1, taken along cross-sectional lines A-A of FIG. 1; and

FIG. 3 is a view of the digestible animal toy of FIG. 1 illustrating the stitching of a barrier shell within an outer shell.

### DETAILED DESCRIPTION

According to various aspects of the present disclosure, a digestible animal toy is provided. The digestible animal toy described herein is not intended as an edible item, per se. However, should an animal rip or otherwise tear into the digestible animal toy, the internal parts of the toy are digestible.

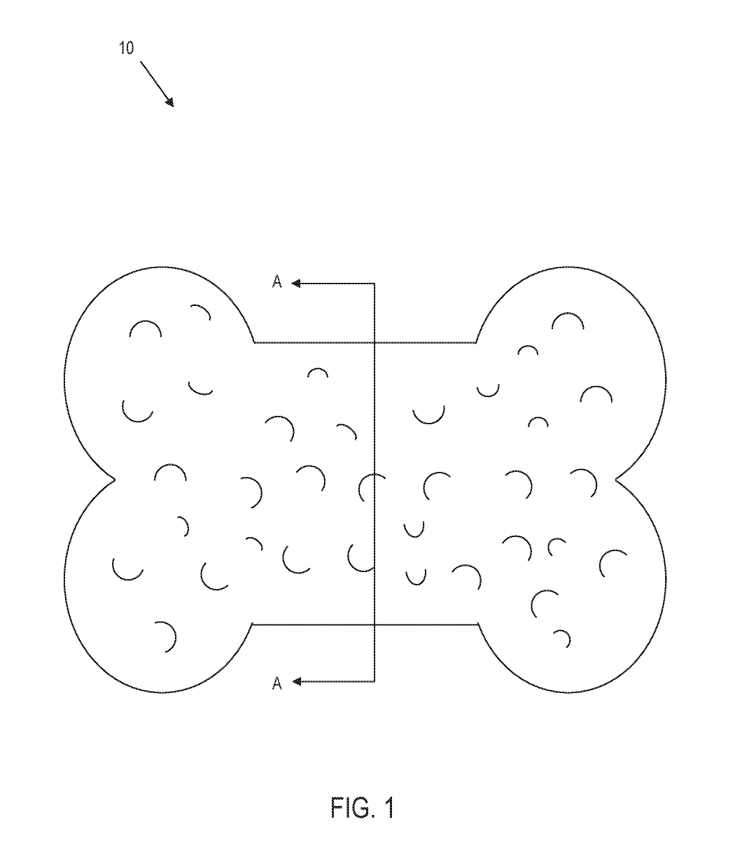

Referring now to the drawings, and in particular to FIG. 1, a digestible animal toy 10 (i.e., pet toy 10) is illustrated, according to various aspects of the present disclosure. The digestible animal toy 10 is shown as a generally “bone” shaped item that is dimensioned to be suitable to be chewed on by an animal. However, in practice, the digestible animal toy 10 may be any desired shape, e.g., ball, disk, etc. Moreover, in practice the size of the animal toy 10 can be sized to any suitable dimensions that are suitable for the animal to which the digestible animal toy 10 is intended. As illustrated, the animal toy 10 is a soft structure, e.g., having a fleece outer shell that attracts the animal to want to chew on the animal toy 10. However, in practice, the outer shell can take on other materials, as will be described in greater detail herein.

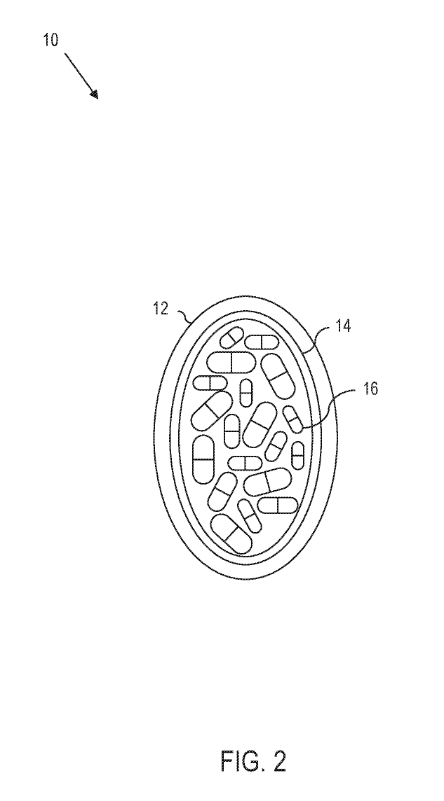

Referring to FIG. 2, the digestible animal toy 10 is illustrated taken along cross-section A-A in FIG. 1. The digestible animal toy 10 includes in general, an outer shell 12, a barrier shell 14, and a filling 16.

The outer shell 12 essentially forms an outer casing that contains the barrier shell 14, and filling 16. Thus, the outer shell 12 defines a first interior volume therewithin. The outer shell 12 may be constructed from a fabric material, such as a fleece fabric that is wrapped into a desired shape that forms the outer shell. In this regard, an outside surface of the outer shell1 12 may have a “wooly” texture that is appealing to the animal for which the toy is intended. An inside surface of the fabric material may be the same as the outside surface, or the inside surface may comprise a backing layer, etc. In this regard, the outer shell 12 may define a flimsy, firm, rigid, or other structure. However, the outer shell 12 should not be “bone” hard and should not damage the enamel of an animal's teeth due to chewing on the animal toy 10.

A barrier shell 14 is concealed within the first internal volume of the outer shell 12. The barrier shell 14 thus defines a second interior volume therewithin, i.e., container, within the animal toy 10. The barrier shell 14 is comprised of a moisture barrier that prevents moisture from passing from the outer shell 12 into the second interior volume and thus within the barrier shell 14. For instance, the barrier shell 14 may comprise a vinyl or vinyl-backed material, plastic, or other waterproof, non-toxic fabric. In this regard, the barrier shell 14 may also optionally prevent, minimize, or otherwise mask scents, e.g., the scent of the filling 16 from escaping animal toy 10. Thus, the animal playing with the animal toy 10 is not incentivized to tear open the animal toy 10 due to the smell of the filling 16.

The filling 16 is provided within the second interior volume, i.e., within the barrier shell 14. As illustrated, the filling 16 is implemented as a plurality of capsules contained within the second interior volume of the barrier shell 14, that are water-dissolvable and non-toxic. For instance, the capsules may comprise gelatin capsules made from pig or beef. In this regard, the capsules may be designed to dissolve in water in a preset amount of time, e.g., about 10 minutes. Moreover, the capsules are non-toxic. Given the size of the capsules and the dissolvable nature of the capsules, the filling should not cause blockage in the animal, should the animal inadvertently consume the capsules. Moreover, the capsules should not cause other internal problems that would otherwise require medical attention. As an illustrative example, capsules by Torpac, Inc. of Fairfield N.J. may be used.

In an illustrative example, the capsules may comprise capsules of varying sizes, shapes, or combinations thereof. In other implementations, the capsules may be the same size, shape, etc.

In an illustrative implementation, the digestible animal toy 10 is provided for an animal such as a dog. The digestible animal toy 10 is not intended to be edible or a food item for the dog. Rather, the digestible animal toy 10 is intended as a chew toy for use by the dog, e.g., for play. A dog will naturally drool and/or salivate on the digestible animal toy 10. As noted above, the capsules are water-dissolvable. However, because the capsules 16 of the filling are contained within the second interior volume of the barrier shell 14, the dog's saliva will not break down the capsules, so long as the barrier remains uncompromised. Moreover, the warm and moist environment of the animal's mouth will not cause the capsules of the filling 16 to break down due to the moisture barrier formed by the barrier shell 14.

In implementations where the barrier shell 14 is implemented by a material such as vinyl, the barrier shell 14 provides resistance to water penetration. In this regard, the barrier shell 14 is constructed to define a sealed, water-tight compartment that houses the filling 16. Because the filling 16 (e.g., liquid-dissolvable capsules) is contained in a sealed, waterproof compartment, it is possible to gently wash/launder the toy 10 to clean the toy 10.

As an example, the vinyl may be implemented as a waterproof, marine grade vinyl forming a durable barrier. The barrier shell 14 may also comprise a vinyl material such as tablecloth material, plastic material or other suitable water-tight, puncture resistant, non-toxic materials. In this manner, the outer shell 12 and the barrier shell 14 combine to yield a soft yet durable toy 10.

Moreover, the barrier shell 14 provides protection and resistance to punctures due to the dog's teeth biting into the digestible animal toy 10. In this regard, barrier shell 14 characteristics such as thickness, durability, resistance to puncture, etc., may vary due to expected characteristics of animals intended to chew on the toy 10. For instance, a toy 10 intended for large dogs may have a thicker barrier layer 14 compared to an animal toy 10 intended for small animals.

However, should the animal, e.g., dog, somehow rip open the digestible animal toy revealing the filling 16, then the animal can safely digest the capsules defining the filling 16 therewithin. The capsules, if ingested, will dissolve in the stomach of the animal. Moreover, the capsules are non-toxic, and will not cause blockage in the animal's digestive system or esophageal tracts. Moreover, the capsules are easy to clean up should they spill out of a compromised toy 10.

The capsules are preferably empty. However, the capsules may alternatively be filled, so long as the filling is digestible. Regardless, since the capsules themselves may be made from beef or pig, the barrier shell 14 may also provide an odor barrier that prevents the smell of the capsules from enticing the animal to rip into the digestible animal toy 10.

As noted above, the capsules may be filled with a safe-to-digest material. However, if the capsules are filled, the filling material should be free of scent that would penetrate the barrier shell 14 and incentivize the animal to rip the digestible animal toy open, e.g., where the barrier shell 14 does not otherwise effectively prevent an animal from smelling the filling 16. It is alternatively possible to use scented filling material where the scent cannot ultimately escape the outer layer 12, e.g., due to the barrier layer 14.

Moreover, as noted in greater detail herein, in certain implementations, the capsules may be of different sizes. Providing different sized capsules provides for different “feels” to the animal toy 10 as the toy is being chewed on.

According to further aspects of the present disclosure, the capsules may be relatively tightly packed in the second interior volume or the capsules may be otherwise sufficient in number to substantially fill the second interior volume. In this manner, as the animal chews on the digestible animal toy 10, the capsules will rub against each other making a squeaking sound in response to being chewed, which animals may enjoy. Moreover, the filling can make a “shaking” sound in response to the capsules hitting each other in response to the animal shaking the digestible animal toy.

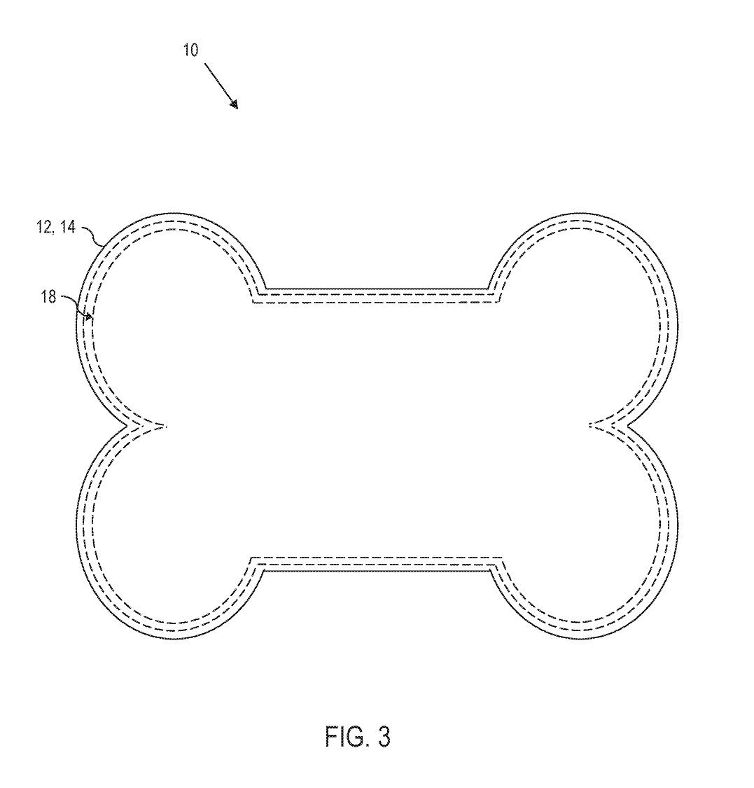

Referring to FIG. 3, the barrier shell 14 may be stitched to the inside of the outer shell 12. For instance, a double stitch 18 may be used. The double stitch prevents the fabric from raveling, since it's stitched twice. The double stitching pattern (or other suitable pattern) may also be used to prevent the outer shell 12 from fraying into long, thin pieces that can be digested by the animal. For instance, the vinyl backing provides a tear-resistant backing material to the fleece outer shell 12.

Accordingly, a digestible animal toy is provided, which is soft and durable. The filling adds noise to mimic the sound of a live animal, which entices that animal, e.g., pet dog, to want to chew on the animal toy 10. Should the pet rip the animal toy 10 open, the internal filling, if ingested, will dissolve in the stomach of the pet, and is non-toxic. Also, should the animal rip the digestible animal toy open, the filling is easy to clean up as the capsules are preferably empty. Additionally, there are no removable parts that could create a foreign body blockage inside the animal. For instance, the noise of the toy is created by water dissolvable capsules, not a plastic squeaker often found in animal toys. Conventional squeakers can be harmful and even deadly to animals if ingested.

According to further aspects of the present disclosure, the animal toy 10 is free of removable parts other than the filling 16 (and barrier layer 14), e.g., buttons, plastic parts, strings, loosely applied decorative fabrics, internal stuffing, etc., that can cause foreign body blockage or laceration to the digestive or esophageal tract of the animal.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure.

Having thus described the invention of the present application in detail and by reference to embodiments thereof, it will be apparent that modifications and variations are possible without departing from the scope of the disclosure defined in the appended claims.

What is claimed is:

1. An animal toy comprising:
an outer shell defining a first internal volume therewithin, the outer shell comprised of a fabric material;
a barrier shell concealed within the first internal volume of the outer shell, the barrier shell defining a second interior volume therewithin, the barrier shell comprised of a moisture barrier that prevents moisture from passing from the outer shell into the second interior volume; and
a filling defined by a plurality of capsules contained within the second interior volume of the barrier shell, that are water-dissolvable.

2. The animal toy according to claim 1, wherein the outer shell comprises a fleece fabric wrapped into a desired shape that forms the outer shell.

3. The animal toy according to claim 1, wherein the barrier shell comprises a vinyl material.

4. The animal toy according to claim 1, wherein the barrier shell is double-stitched to the outer shell.

5. The animal toy according to claim 1, wherein the plurality of capsules comprise gelatin capsules made using at least one of beef or pig.

6. The animal toy according to claim 1, wherein the plurality of capsules comprise gelatin capsules having a plurality of different sizes.

7. The animal toy according to claim 1, wherein the plurality of capsules are sufficient in number to substantially fill the second interior volume such that capsules rub against each other and squeak in response to being chewed.

8. The animal toy according to claim 1, wherein the plurality of capsules are sufficient in number to substantially fill the second interior volume such that capsules rub against each other and make a shaking sound in response to being shaken.

9. The animal toy according to claim 1, wherein the barrier shell prevents the scent of the plurality of capsules from being detected by an animal chewing on the animal toy.

10. The animal toy according to claim 1, wherein the animal toy is free of removable parts other than the filling.

11. A method of making an animal toy comprising:
providing an outer shell defining a first internal volume therewithin, the outer shell comprised of a fabric material;
providing a barrier shell concealed within the first internal volume of the outer shell, the barrier shell defining a second interior volume therewithin, the barrier shell comprised of a moisture barrier that prevents moisture from passing from the outer shell into the second interior volume; and
filling the second interior volume with a filling defined by a plurality of capsules that are water-dissolvable.

12. The method according to claim 11 further comprising forming the outer shell into a desired shape using a fleece fabric.

13. The method according to claim 11 further comprising forming the barrier shell out of a vinyl material.

14. The method according to claim 11 further comprising double stitching the barrier shell to the outer shell.

15. The method according to claim 11, wherein filling the second interior volume with a filling defined by a plurality of capsules that are water-dissolvable, comprises:
filling the second interior volume with gelatin capsules made using at least one of beef or pig.

16. The method according to claim 11, wherein filling the second interior volume with a filling defined by a plurality of capsules that are water-dissolvable, comprises:
filling the second interior volume with gelatin capsules having a plurality of different sizes.

17. The method according to claim 11, wherein filling the second interior volume with a filling defined by a plurality of capsules that are water-dissolvable, comprises:
filling the second interior volume with gelatin capsules sufficient in number to substantially fill the second interior volume such that capsules rub against each other and squeak in response to being chewed.

18. The method according to claim 11, wherein filling the second interior volume with a filling defined by a plurality of capsules that are water-dissolvable, comprises:
filling the second interior volume with gelatin capsules sufficient in number to substantially fill the second interior volume such that capsules rub against each other and make a shaking sound in response to being shaken.

19. The method according to claim 11 further comprising configuring the barrier shell to prevent the scent of the plurality of capsules from being detected by an animal chewing on the animal toy.

20. The method according to claim 11 further comprising assembling the animal toy so as to be free of removable parts other than the filling.
